(19) United States
(12) Patent Application Publication
(10) Pub. No.: US 2002/0120596 A1
(43) Pub. Date: Aug. 29, 2002

(54) Content store with inheritance

(76) Inventors: Matthew Gershoff, New York, NY (US); Nathaniel Weiss, Brooklyn, NY (US)

Correspondence Address: SMITH & HOPEN PA, 15950 BAY VISTA DRIVE, SUITE 220, CLEARWATER, FL, 33760

(21) Appl. No.: 09/681,214

(22) Filed: Feb. 24, 2001

(51) Int. Cl. G06F 7/00

(52) U.S. Cl. 707/1

(57) ABSTRACT

A method of managing a plurality of related publications including the steps of establishing a plurality of relational database tables further including: at least one parent manual table; at least one content table in relational connection with the parent manual table; at least one procedure table in relational connection with the one parent manual table; at least one child manual table in inheritable relation to the parent manual table and spawning a plurality of child manual tables, all inheriting content and procedures from the parent manual table.

### BACKGROUND OF THE INVENTION

1. Field of the Invention

This invention relates to a novel database system and more specifically, to a means for organizing and inter-relating data or files, including relational, network, hierarchical, and entity-relationship models.

2. Background of the Invention

It is well known that product brands that offer superior post-sale product support inherit goodwill and therefore enhance the value of the brand name. The most common types of support services needed by end users include the knowledge of how to install, assemble, operate, troubleshoot and repair the products they have purchased for, home, office or industrial use. Current trends show that traditional paper-based installation and repair manuals are slowly being replaced by other mediums. Perhaps one of the best examples is that of software development systems such as Microsoft C++, Inprise's Delphi or other products with substantial documentation. Although some paper manuals were always included as a matter of course, software companies turned to CD-ROMs to hold the vast libraries of help files, examples and other related documentation. Both the software company and the end-user benefited from this trend. The software company greatly reduced its hard-copy printing costs and reduced the shipping size and weight of the retail product. The end user typically had some minimal search capabilities thereby providing an enhanced means of resolving a problem or question about the product.

However, CD-ROMs had their drawbacks. Even at approximately 640 MB, limitations did exist on the volume of information that could be shipped. Furthermore, errors in the documentation, updates or critical warnings necessitated a supplemental CD-ROM or paper notice.

With the proliferation of the web in the mid-1990s, static websites provided online documentation that could be easily updated by the product manufacturer. When compared with the costs of paper or CD-ROM document delivery, the costs of posting online contact was minimal by comparison. Troubleshooting and product support on the web became associated with the notorious “FAQ” which stood for “frequently asked questions.” For many applications, the use of a FAQ web page was insufficient in consideration of the volume of documentation available. Employing back-end databases and indexing technologies, search capabilities were added to product support websites and the ubiquitous knowledge base system was created. However, troubleshooting, repair, replacement part sales, operational guidelines, safety warnings, service scheduling, and warranty renewals were fragmented systems which required the end user to jump from one system to another without maintaining persistence in the information viewed.

Another difficulty currently experienced by product support operations is the maintenance of a plurality of substantially similar product manuals. For example, an appliance manufacturer may offer a line of ten different dishwasher that use many of the same parts, have similar repair guidelines and similar operation. Traditionally, the manufacturer would have printed ten different paper manuals for operation, troubleshooting, repair and replacement parts. Manufacturers sometimes combined several very closely related products into one printed publication. However, this was often less than ideal for the end user who was required to constantly differentiate his or her product model from the plurality covered by the single publication.

A possible solution to this problem is a method to combine an object-oriented notion of inheritance with the benefits of a relational database model to enable the storage of book-like product manuals for online publication. Manuals would have a “hierarchical” relationship to one another. “Child” manuals would inherit content from “parent” manuals. However, before the present invention, such a system was undisclosed.

In Muller's Database Design for Smarties, he provides discussion on inheritance in Chapter 2, pages 49-51. Although Orcale8 and DB2 V2 do not support inheritance, Informix Dynamic Server provides inheritance of types and of tables. Muller makes several discussions of the object-relational database model (ORDBMS) and the upcoming ISO standard, SQL3 that addresses it. However, the Muller reference does not disclose nor suggest a method to achieve the above-mentioned requirements.

U.S. Pat. No. 6,047,284 to Owens et al. describes a method and apparatus for object oriented storage and retrieval of data from a relational database. A class of objects stored in a relational database are defined, the objects of the class having at least one member. One or more relational database tables are created to store the objects of the class and each data member is mapped to at least one column in the relational database tables. Subclasses of objects may be defined that inherit the data members of a parent class. The data members for objects of the subclass are typically stored in additional relational database tables. (Col. 2, lines 39-49).

U.S. Pat. Nos. 5,850,544 and 5,829,006 to Parvathaneny et al. describe an object-relational database gateway. The gateway includes a query generator to generate from an object-oriented query a set of relational queries. The object-oriented query identifies one or more target objects of a target class that are desired to be constructed. The set of relational queries, when processed, enable to the RDBMS to retrieve rows of a table required to initialize base attributes of the target objects that are defined by the target class and by any super-classes and sub-classes of the target class. (Col. 2, lines 19-26 of the '544 patent).

U.S. Pat. No. 5,659,723 to Dimitrios et al. describes a method of converting relational program modeling into object-oriented form. U.S. Pat. No. 5,499,371 to Henninger et al. describes a method to automatically map information between an object-oriented database and a relational database. The method comprises accepting a user-defined object model as a “blueprint” for an object-oriented application; accepting or constructing a schema of the structure of data in a database; and accepting or constructing a transform defining the mapping between the database schema and the object model. (Col. 3, lines 12-17).

U.S. Pat. No. 5,335,346 to Fabbio describes an access control system for distributing security permissions across an object-oriented database. U.S. Pat. No. 5,161,225 to Abraham et al. describes a method for handling queries to an object-oriented database. U.S. Pat. No. 5,838,965 to Kavanagh et al. describes an object-oriented database management system for parts inventory.

Accordingly, what is needed in the art is an improved system to maintain manuals for similar products that may have only small differences from one another. It is, therefore, to the effective resolution of the aforementioned problems and shortcomings of the prior art that the present invention is directed.

However, in view of the prior art in at the time the present invention was made, it was not obvious to those of ordinary skill in the pertinent art how the identified needs could be fulfilled.

### SUMMARY OF INVENTION

The present invention comprises a method of managing a plurality of related publications. The steps first comprise establishing a set of media content pieces. These media content pieces may include, but are not limited to, text, image, flash, mp3, wav, avi, or mpg files. These files are well known for online publication using the HTML standard. In the next step, the media content pieces are arranged into a procedure. A procedure is an ordered set of the media content pieces. For example, a procedure might order an arrangement of media content pieces as “text-image-text-avi.” The procedures are aggregated into a parent manual. The parent manual is an ordered aggregate of procedures. Next, at least one child manual is created that inherits the ordered aggregate of procedures in the parent manual. Any change in the parent manual is inherited by the child manual. However, changes in the child manual are not inherited by the parent manual. The same principle is applied to procedures which may also be set in a hierarchy.

Accordingly, when at least one modification is stored in the parent manual the step includes descending the modification to the child manual wherein changes to the parent manual are inherited by the child manual. Alternatively, inheritance may be selectively broken wherein changes to the parent manual are not inherited by the child manual.

Links between content groups may be created by establishing a first selection of media content, establishing a second selection of media content, establishing a zone related to the first selection, and linking the zone to the second selection. As an alternative to linking the zone to the second selection, the zone may be linked to a procedure.

Formatting may be inherited between procedures by establishing an array of predefined formatting instructions and associating the array of predefined formatting instructions with a procedure. The same may also be done between manuals by establishing an array of predefined formatting instructions and associating the array of predefined formatting instructions with a manual.

However, in the preferred embodiment, each piece of content is mapped to a role. The role in turn is mapped to a format. The mapping between role and format is conditional on the manual and procedure. For example, a piece of text may be mapped to a role named “Notice”. The role, Notice, can be mapped to different formats within the same manual. When the mapping between Notice and Callout first takes place, the system goes through the manual and makes the mapping for all procedures nested below the procedure where the mapping takes place. One the system has made the change in all nested levels it then finds the children manuals and does the same. If the mapping changes (say Notice gets mapped to Callout2) in one of the original procedures sub procedure then the system remaps Notice to Callout2 for the sub procedure and all of its sub proceduresIn many cases, it is desirable to selectively present information according to a predefined skill level such as “novice” or “expert.” That feature may be achieved by mapping an array of predefined skill levels and associating the array of predefined skill levels with content. The feature may also be applied across a manual by establishing an array of predefined skill levels and associating the array of predefined skill levels with a procedure or manual.

The method includes establishing a plurality of relational database tables comprising, at least one parent manual table, at least one content table in relational connection with the parent manual table, at least one procedure table in relational connection with the parent manual table, at least one child manual table in inheritable relation to the parent manual table and spawning a plurality of the child manual table inheriting content and procedures from the parent manual table.

To enable content to be categorized into groups such as “callouts” or “sidebars,” roles may be established by including at least one role table in relational connection with the parent manual table. To enable links between content pieces, zones may be created by including at least one zone table in relational connection with the parent manual table. To establish the visual format of role, formats may be provided by including at least one format table in relational connection with the parent manual table.

It is therefore an object of the present invention to provide a method of creating and maintaining a plurality of related publications without redundant data entry.

It is another object of the invention to maintain relationships between trees of text and file-based content.

An advantage of the invention is that maintaining related stores of information is more efficient. Content used in multiple places is only entered once and changes to the content need only be made in one location.

Another advantage of the invention is of consistency because the data that is used in multiple locations is stored in one location.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a database layout for a parent manual table.

FIG. 2 is a database layout for a manual table.

FIG. 3 is a database layout for a procedures table.

FIG. 4 is a database layout for a content procedure table.

FIG. 5 is a database layout for a procedure format table.

FIG. 6 is a database layout for a role table.

FIG. 7 is a database layout for a zone table.

FIG. 8 is a database layout for a content zone table.

FIG. 9 is a database layout for a content table.

FIG. 10 is a database layout for a procedure content table.

FIG. 11 is a database layout for a content text table.

FIG. 12 is a database layout for a content images table.

FIG. 13 is a database layout for a format table.

FIG. 14 is an interface display showing a manual manager.

FIG. 15 is an interface display showing an author palette.

FIG. 16 is an interface display showing an illustrative example of an online publication displayed by the invention.

FIG. 17 is an interface display showing a manual chooser dialog box.

FIG. 18 is an interface display showing a parts manager.

FIG. 19 is an interface display showing a parts properties dialog box.

FIG. 20 is an interface display showing an assignment of products to a part dialog box.

FIG. 21 is an interface display showing a new manual dialog box.

FIG. 22 is an interface display showing a page formatting dialog box.

### DETAILED DESCRIPTION

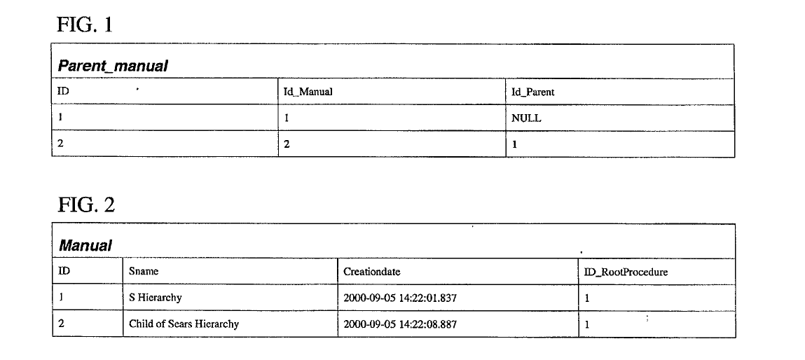

FIG. 1 shows the database layout for the PARENT_MANUAL. In the preferred embodiment, the PARENT_MANUAL has three fields, an auto-number {ID} field, an {ID_Manual} field and an {ID_Parent field}. As with most relation database tables, a primary key is created which is incrementally numbered to establish an absolute identity of a particular row. The {ID_Manual} is an assignable field and the {ID_Parent} establishes inheritance between manuals. It can be seen in the first row that a NULL value is entered for the top-level parent manual, as it cannot have a parent.

In FIG. 2, the layout for the MANUAL table is provided with four columns: an auto-number {ID} field to establish an absolute identity, an {Sname} column for a descriptive text string, a {Creationdate} field to date-time stamp the row creation, and an {ID_RootProcedure}, which is the initial procedure of the manual (even a parent manual has a {ID_RootProcedure}). The {ID_RootProcedure} is the starting point for the manual. Both procedures and standard content can be added to the root (think of the root as the c:\ drive it comes with the computer). All of the procedures in the root are selected and place them in a table of contents (TOC). Then when a user select any of the TOC procedures the associated content is selected.

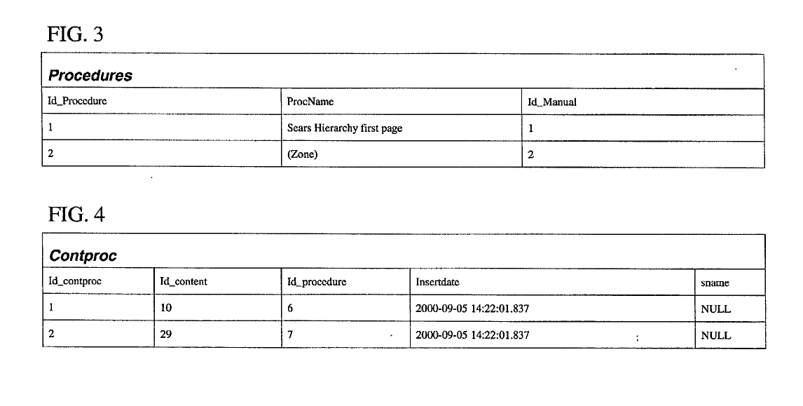

In FIG. 3, the layout for the PROCEDURES table is provided with three columns: an auto-number {ID} field to establish an absolute identity, a {ProcName} column for a descriptive text string, and an {ID_Manual}.

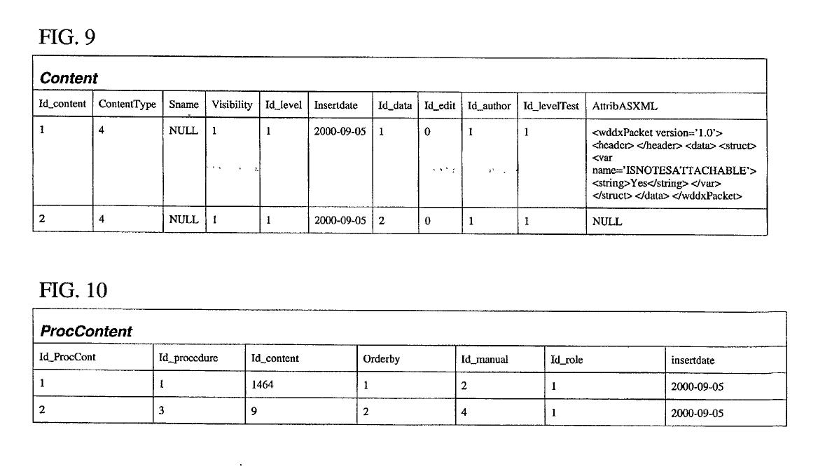

The layout for the ContProc table is provided in FIG. 4. An {ID_contproc} column provides an auto-number field to establish an absolute identity, an {ID_content} relates to a content table row as will be shown in FIG. 9, an {ID_Procedure} column relates to a table row in the procedure manual of FIG. 3, an {InsertDate} field records the time and date the row was inserted, and the {sname} field provides a descriptive text string field.

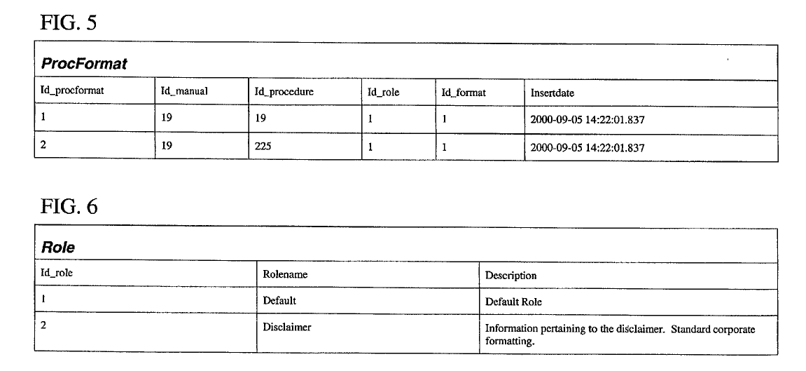

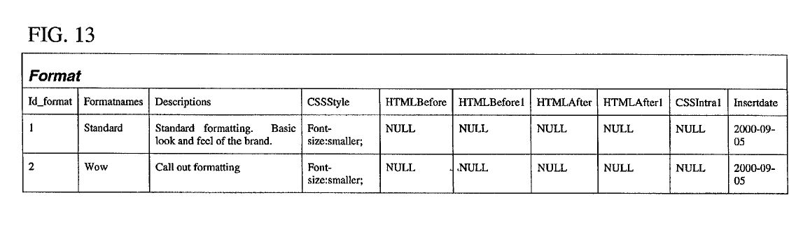

FIG. 5 illustrates the structure for the ProcFormat table which includes an {ID_procformat} auto-number ID field to establish an absolute identity, an {ID_manual} field which relates to the ID field of FIG. 2, an {ID_procedure} field which relates to the {ID_Procedure} field of FIG. 3, an {ID_role} field which relates to the auto-number field as will be described in FIG. 6, an {ID_format} field which relates to the auto-number field as will be described in FIG. 13, and an {InsertDate} field which records the time and date the row was inserted. The ProcFormat table maps roles and formats together. The mapping is at the manual procedure level such that a role will be mapped to only one format for a particular manual-procedure combination.

FIG. 6 shows the layout of the Role table wherein {ID_role} is an auto-number ID field to establish an absolute identity, {Rolename} is a short text string title for the row and {Description} is a longer text string description for the row.

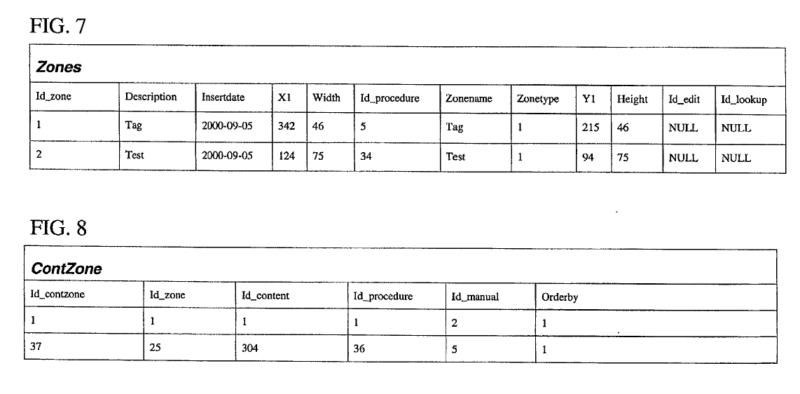

FIG. 7 illustrates the layout of the Zone table wherein {ID_Zone} is an auto-number ID field to establish an absolute identity, {Description} is a short text string title, {InsertDate} records the time and date the row was inserted, {X1} provides an x-axis coordinate in pixels, {Width} specifies the width of a zone in pixels, {ID_procedure} relates to the {ID_procedure} field of FIG. 3, {ZoneName} is a text description of the zone, {Zonetype} is a numeric field for identifying the type of zone, {Y1} provides a y-axis coordinate in pixels, {Height} specifies the height of the zone in pixels, {Id_edit} tracks information about revisions, and {Id_lookup} Id_lookup is used when it is desired that the zone link to something other than a procedure. So the combination of zone type and id_lookup tell the system where to find the data. Normally the zone links to a procedure (through the id_procedure column but it was found there were times where it was preferable to link to other datasources (for example the a zonetype 2 is a troubleshooter response and the id_lookup maps to the id_response in the response table).

FIG. 8 shows the layout of the ContZone table wherein {ID_contzone} is an auto-number ID field to establish an absolute identity for each row, {ID_zone} relates to the same column in FIG. 7, {ID_content} relates to a content row as will be described in FIG. 9, {ID_procedure} relates to the column of the same title in FIG. 3, {ID_manual} relates to the {ID} field of the manual table in FIG. 2 and the {OrderBy} field establishes the order in which content is present. The ContZone is analogous to the ProcContent table as it maps a particular configuration of the manual, procedure and content to a particular zone. By establishing the relationship at the manual, procedure and content level, it is possible to provide different zones to the same piece of content in different locations within the system whether it is a different manual or different procedure. If the {ID_Content} field is mapped only to the {ID_Zone} field, the system would be constrained to the same set of zones regardless of location.

FIG. 9 shows the layout of the Content table wherein {ID_Content} is an auto-number ID field to establish an absolute identity for each row, {ContentType} provides a numerical field, {Sname} provides a text string field to describe a content object, {Visibility} provides a field for determining whether the content may be viewed, {ID_level} specifies the expertise level of the content. For example a piece of content can be marked as 1 (novice) or 2 (expert). {Id_level} must be used to determine if the current user should be able to view the content {InsertDate} records the time and date the row was inserted, {Id_Data} is the value of the primary key in the associated content type tables (CONTTEXT, CONTIMAGE, etc.). The system looks at the {ContentType} field to determine which data table to use. The data id can then be used to match the content to the data.

When a piece of content gets edited or deleted a new row in the content table is created. The {Id_edit} in the new row contains the {ID_Content} of the edited content. Then the {ID_Content} field in the {ProcContent} table is updated with the new {ID_Content}. So when we select records from the {ProcContent} table to build the manual only the most recent edition of the content is seen. When content is deleted the same process occurs except that the {Id_Data} (the look up to the actual content (test, image, etc.)) is set to null. Newly created content have null values in the {Id_edit} field. {ID_edit} incrementally increases in numeric value so that changes to content may be rolled back, {ID_author} records the identity of the author inserting the record, {Id_leveltest} is used with {ID_level} to determine if a piece of content should be viewed by a user. The current tests are “this level and above (1)”, “this level and below (2)” “Only this level (3)”, “All but this level (4)”. For example if a piece of content is tagged as novice with a level test of 1 then everyone should be able to see the content. If the level is “expert” and the test is 2 only novice and expert will see the content (so level 3 and above will not see the content) and {AttribASXML} holds various display characteristics of the content in XML.

FIG. 10 shows the layout of the ProcContent table wherein {ID_ProcCont} is an auto-number ID field to establish an absolute identity for each row, {ID_Procedure} relates to the {ID_Procedure} of FIG. 3, {ID_Content} relates to the {ID_Content} field of FIG. 9, {Orderby} establishes the order in which the content will be displayed, {ID_Manual} relates to the {ID} field of FIG. 2, {ID_Role} relates to the {ID_Role} field of FIG. 6, and {InsertDate} records the time and date the row was inserted. The ProcContent table maps {ID_Manual}, {ID_Procedure} and {ID_Content} together. Therefore, if the manual table in FIG. 2 has three procedures with two pieces of content in each procedure, the ProContent table will have six rows corresponding to the manual table. The {Orderby} establishes the order of contents within a procedure. As shown in FIG. 10, the {Orderby} field has values of 1 and 2 (one piece of content will be first in the order and the other will be second). The {Orderby} field tells the web front end how to position the content relative to one another.

FIG. 11 illustrates the layout of the ContText table wherein {ID_text} is an auto-number ID field to establish an absolute identity for each row, {ID_Content} relates to the {ID_Content} field of FIG. 9, {Name_text} is a title text string, {TextBlock} is a body text string, and {InsertDate} records the time and date the row was inserted.

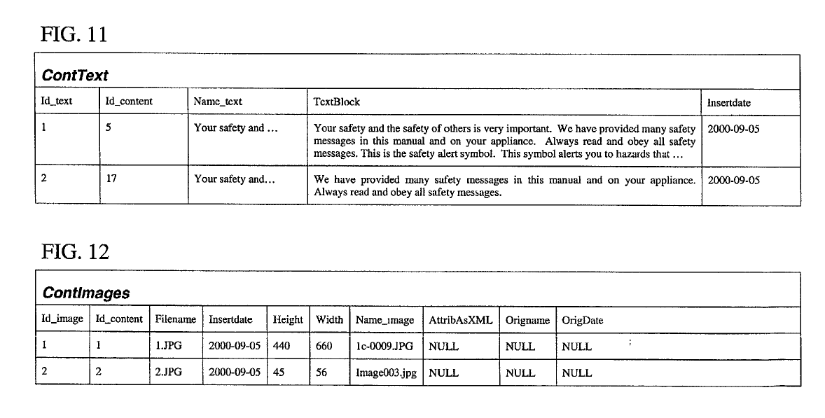

FIG. 12 illustrates the layout of the ContImages table wherein {ID_image} is an auto-number ID field to establish an absolute identity for each row, {ID_Content} relates to the {ID_Content} field of FIG. 9, {Filename} holds the record-based filename of the image with its appropriate type-extension, {InsertDate} records the time and date the row was inserted, {Height} provides the number of pixels the image is high, {Width} provides the number of pixels the image is wide, {Name_image} provides the original file name of the image, {AttribAsXML} holds various display characteristics of the content in XML, {Origname} is the original name of the file being imported into the system and {OrigDate} is the creation date of the original file when it was imported into the system.

FIG. 13 provides the structure of the Format table wherein {ID_format} is an auto-number ID field to establish an absolute identity for each row, {Formatnames} is a short text string title of the record, {Descriptions} is a detailed text string describing the record, {CSSStyle} provides a text field for formatting instructions based on cascading style sheets, {HTMLBefore} provides a text field for adding HTML code before every piece of content under the format, {HTMLBefore1} is the same as {HTMLBefore} except that it only applies to the first line of text {HTMLAfter} provides a text field for adding HTML code after every piece of content under the format, {HTMLAfter1} is the same as {HTMLAfter} except that it only applies to the last line of text {CSSIntral} provides the same role as {CSSStyle} but only for the first line of text, and {InsertDate} records the time and date the row was inserted. It should be noted that HTMLBefore1, HTMLAfter1 and CSSIntral are applicable for text content only.

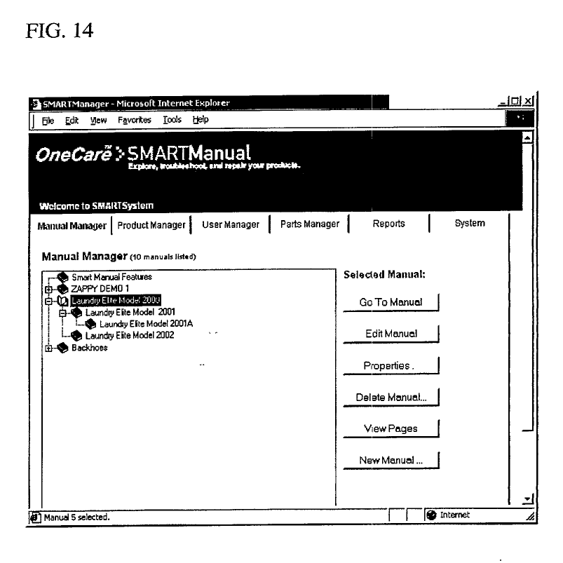

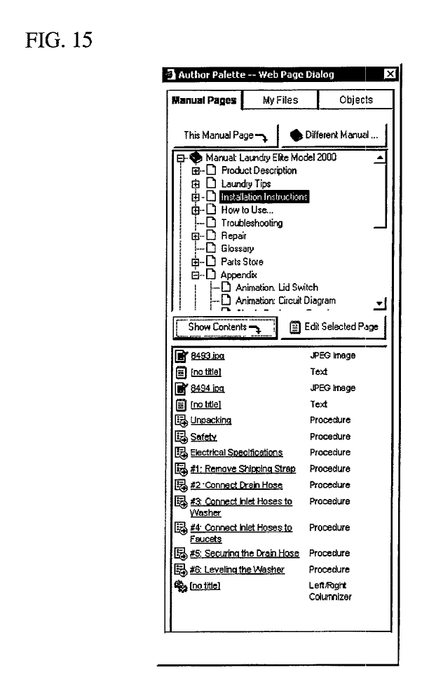

FIG. 14 shows a graphic user interface (“GUI”) for managing a plurality of content manuals and the inheritance shared between them. In the GUI, a parent manual entitled “Laundry Elite Model 2000” is highlighted. Beneath the parent manual are two child manuals entitled “Laundry Elite Model 2001,” and “Laundry Elite Model 2002.” Each of the two child manuals inherit the properties of the parent manual, “Laundry Elite Model 2000.” Furthermore, another child manual, “Laundry Elite Model 2001 A,” is descended from “Laundry Elite Model 2001.” Accordingly, changes made to the “Laundry Elite Model 2000” parent manual are inherited by child manuals. Changes made to “Laundry Elite Model 2001” are inherited by only “Laundry Elite Model 2001A” because it is a descendant. The parent manuals displayed in FIG. 14 consist of “Smart Manual Features,” “ZAPPY DEMO 1,” “Laundry Elite Model 2000,” and “Backhoes.” FIG. 15 shows an author palette for the “Laundry Elite Model 2000” manual. The object-based display is evident from the collection of page headings in the upper windowpane and the grouping of individual objects in each page in the lower windowpane. As shown, the individual objects may be JPEG images, text and procedures. The procedures encapsulate an array of images, text and formatting as an object even though the schema enjoys the benefits of a relational database.

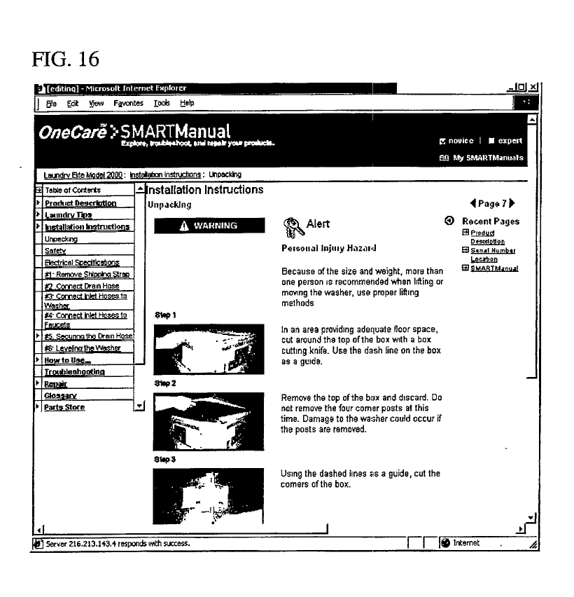

FIG. 16 illustrations the GUI display of the content of FIG. 15. The view of FIG. 16 comprises substantially three windows, a top banner, a left table of contents, and a right content display. The top banner in this case displays the trade names of the illustrative embodiment. The left table of contents displays the various sections to the “Laundry Elite Model 2000” manual. The various sections correspond to listings of the top windowpane view in FIG. 15. The right content display of FIG. 16 shows the procedures, text and images associated with the appropriate subject of the manual.

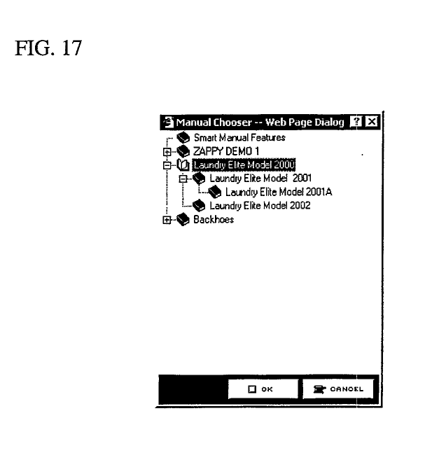

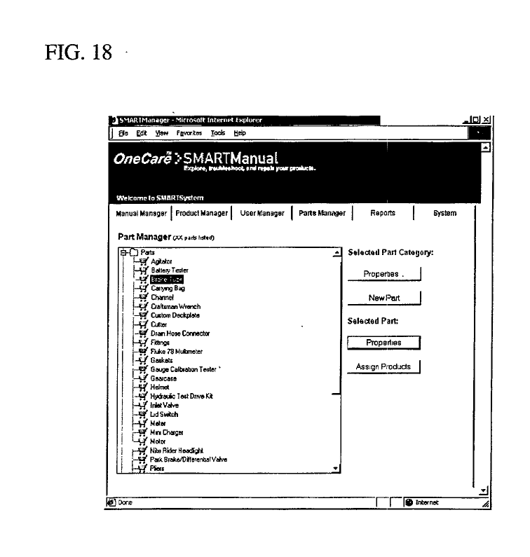

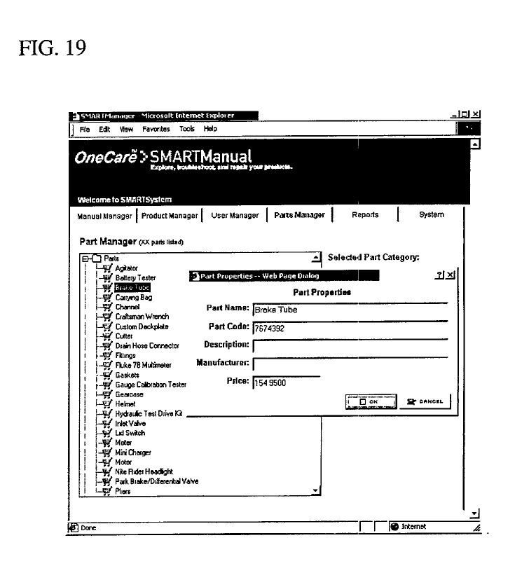

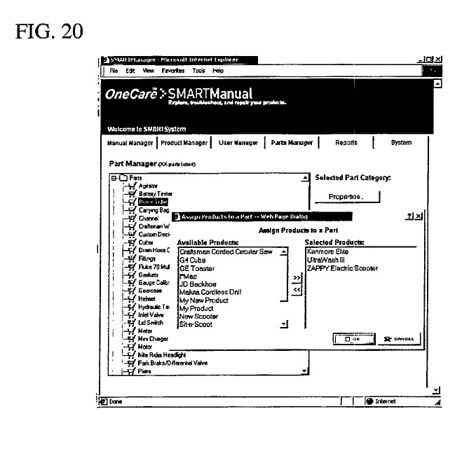

FIG. 17 shows a dialog box for switching between manuals. The hierarchy of the manuals may be viewed by the tree structure. FIG. 18 illustrates a part manager in the illustrative embodiment of the invention. As can be seen by the buttons on the GUI, properties of the part category as well as the individual part may be modified. FIG. 19 shows a dialog box for modifying an individual part's property. In this case, it is for a brake tube. The part code, description, manufacturer and price may be easily adjusted. However, what if a single part is usable within multiple manuals? FIG. 20 shows a dialog box that assigns products to a part. In this base, the brake tube may be used with the Kenmore Elite, UltraWash III and ZAPPY Electric Scooter. Again, the relational database schema maintains the relationships and inheritance while the object-oriented GUI provides the simplicity of data encapsulation.

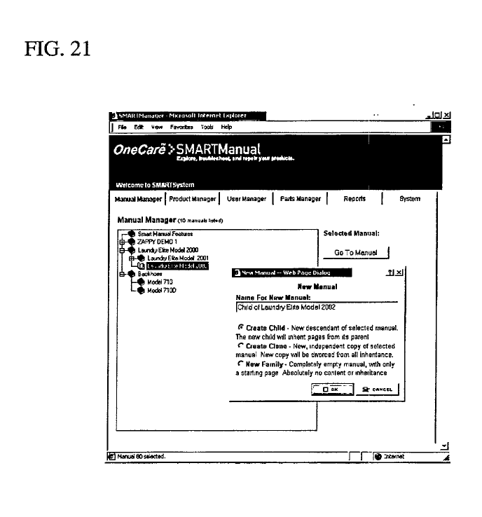

FIG. 21 illustrates the creation of a new manual. Three options exist: (1) a child manual may be created that will inherit the pages of the parent manual; (2) a new, independent clone of the parent manual may be created which will break inheritance from the parent manual; and (3) a blank manual may be created with no content, nor inheritance, also known as a root manual.

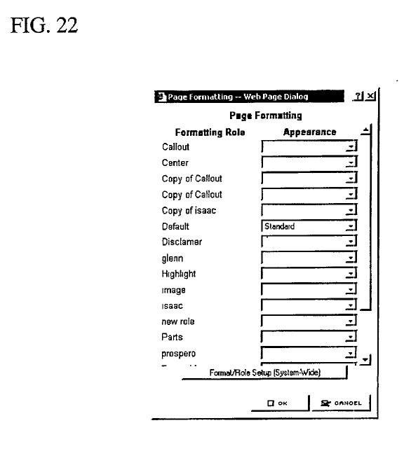

FIG. 22 illustrates a page formatting dialog box that permits mapping of a role to a format.

When new content is added, the method takes into account the manual inheritance. When a new piece of media content is added to a manual, the content is identified by type (i.e., text, image, etc.) and is given a unique content identification. Depending on the content type, the information is placed into the appropriate data table (e.g., Conttext of FIG. 11 or Contimages of FIG. 12). In the next step, the method finds all of the children manuals under the parent manual where the content is being added. The method loops through all of the manuals and inserts a new record into the ProContent table (FIG. 10) with the {ID_manual} at the current iteration, the {ID_procedure} and the {ID_Content} fields. At each iteration, there is a validation to determine if the child manual had the current procedure. If not, then a new record is not inserted into the ProcContent table. This permits child manuals to selectively break inheritance for unwanted procedures. If placement was specified relative to an existing piece of content in the procedure, then the {Orderby} field will reflect the position. Otherwise, the content will be placed at the end of the procedure.

A similar concept to inheritance is the notion of nested procedures. Each manual is comprised of a set of order procedures. Each procedure may have any number of nested procedures (child procedures). When a blank manual is created, a new procedure is also created and its {ID_Procedure} is placed into the manual table in the {ID_RootProcedure} field. All new procedures that are added to the manual are nested in (are a child of) the root procedure. Unlike manual inheritance, there is no table that explicated defines this relationship. Instead, a new procedure is a piece of content of the parent procedure. The {ID_Content} field maps to a record in the content table (FIG. 9) that indicates the type of content it is (e.g., {ContentType}), in this case it is a procedure. This tells the system to look into the ContProc table (FIG. 4) and find the {ID_Procedure} field that is associated with the current {ID_Content} value.

There are three types of manuals that can be created: new family, child and clone. A new family manual is completely blank manual that has no parent manual. When the system creates a new family it creates a new record in the manual table, the Parent_Manual table (with the {ID_Parent} field equal to the {ID} field of the MANUAL table) and a new procedure that serves as the root procedure {ID_RootProcedure}of the new manual.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A method of managing a plurality of related publications comprising:
establishing a set of media content pieces;
arranging a sub-set of media content pieces into a procedure;
aggregating at least one procedure into a parent manual; and
spawning at least one child manual inheriting the at least one procedure of the parent manual.

2. The method of claim 1 further comprising:
storing at least one modification to the parent manual; and
descending the at least one modification to the child manual wherein changes to the parent manual are inherited by the at least one child manual.

3. The method of claim 2 wherein changes to the parent manual are not inherited by the at least one child manual.

4. The method of claim 1 further comprising:
establishing a first selection of media content;
establishing a second selection of media content;
establishing a zone related to the first selection; and
linking the zone to the second selection.

5. The method of claim 1 further comprising:.
establishing a first selection of media content;
establishing a zone related to the first selection and
linking the zone to a procedure.

6. The method of claim 1 further comprising:
establishing an array of predefined formatting instructions and
associating the array of predefined formatting instructions with a procedure.

7. The method of claim 1 further comprising:
establishing an array of predefined formatting instructions and
associating the array of predefined formatting instructions with a manual.

8. The method of claim 1 further comprising:
establishing an array of predefined skill levels and
associating the array of predefined skill levels with a procedure.

9. The method of claim 1 further comprising:
establishing an array of predefined skill levels and
associating the array of predefined skill levels with a manual.

10. A method of managing a plurality of related publications comprising:
establishing a set of media content pieces;
arranging a sub-set of media content pieces into a procedure;
aggregating at least one procedure into a parent manual;
spawning at least one child manual inheriting the at least one procedure of the parent manual;
storing at least one modification to the parent manual; and
descending the at least one modification to the child manual wherein changes to the parent manual are inherited by the at least one child manual.

11. A method of managing a plurality of related publications comprising:
establishing a plurality of relational database tables comprising:
at least one parent manual table;
at least one content table in relational connection with the at least one parent manual table;
at least one procedure table in relational connection with the at least one parent manual table;
at least one child manual table in inheritable relation to the at least one parent manual table;
spawning a plurality of the at least one child manual table inheriting content and procedures from the at least one parent manual table.

12. The method of claim 11 further comprising including at least one format table in relational connection with the at least one parent manual table.

13. The method of claim 11 further comprising including at least one role table in relational connection with the at least one parent manual table.

14. The method of claim 11 further comprising including at least one zone table in relational connection with the at least one parent manual table.
